(19) United States
(12) Patent Application Publication
(10) Pub. No.: US 2025/0055062 A1
(43) Pub. Date: Feb. 13, 2025

(54) BATTERY PACK FOR AN ELECTRIC VEHICLE

(71) Applicant: Oben Electric Vehicles Private Limited, Bangalore (IN)

(72) Inventors: Dinkar Agrawal, Bangalore (IN); Sagar Thakkar, Ahmedabad (IN); Shantanu Laxmikant Diwakar, Osmanabad (IN); Sagnik Deb, Hyderabad (IN)

(21) Appl. No.: 18/716,552

(22) PCT Filed: Dec. 6, 2022
(86) PCT No.: PCT/IB2022/061801

§ 371 Date: Jun. 5, 2024

(30) Foreign Application Priority Data
Dec. 11, 2021 (IN) 202141057696

(51) Int. Cl. H01M 10/6551; B62J 43/16; B62J 43/28; H01M 10/613; H01M 10/625; H01M 50/224; H01M 50/249; H01M 50/276

(52) U.S. Cl. CPC H01M 10/6551; B62J 43/16; B62J 43/28; H01M 10/613; H01M 10/625; H01M 50/224; H01M 50/249; H01M 50/276; H01M 2220/20

(57) ABSTRACT

A battery pack for an electric vehicle is disclosed. The battery pack includes a cuboidal case of pre-defined dimension. The cuboidal case is configured to enclose one or more battery cells. The cuboidal case includes four side walls, a base wall and a top cover wall. The four side walls include two opposite long side walls and two opposite short side walls. The two opposite long side walls and the base wall of the cuboidal case is attached with structural fins longitudinally. The structural fins are configured to increase surface area of the cuboidal case and allow heat dissipation by convection process from the one or more battery cells. The battery pack includes a phase change material packed, configured to maintain temperature range at higher discharge and hot temperature regions within the battery pack.

### EARLIEST PRIORITY DATE

This application claims priority from a Provisional patent application filed in India having patent application No. 202141057696, filed on Dec. 11, 2021, and titled “BATTERY PACK FOR AN ELECTRIC VEHICLE” and also claims priority from a PCT patent application Patent Application No. PCT/IB2022/061801, filed on Dec. 6, 2022, and titled “BATTERY PACK FOR AN ELECTRIC VEHICLE”.

### FIELD OF INVENTION

Embodiments of the present disclosure relates to electric vehicles, and more particularly to a battery pack design and placement in an electric vehicle.

### BACKGROUND

Electric vehicles use rechargeable batteries to power electric motors. The batteries include electrodes and an ion conducting electrolyte positioned there between. Normally, battery packs are used in electric vehicles to store such rechargeable batteries. The battery packs are designed to keep the operating temperature of such rechargeable batteries within a particular range. Due to the characteristics of the batteries, the battery pack operates with desired performance within an ambient temperature range of −20° C. to 60° C.

The battery works upon voltage difference between positive and negative terminals. As the power demand of the electric vehicle increases during initial acceleration or during any other operations, current discharge of the battery cells becomes high. High current discharge leads to increase in temperature of the battery. In electric vehicles, discharging of the battery generates heat. In other words, when power demand by vehicle is high in certain instances such as initial acceleration or on gradient, current discharge of battery is very high which leads to increase in temperature of battery pack in operation or working. The more rapidly battery is discharged, the more heat it generates.

Conventionally, the batteries work on the principle of a voltage differential, and at high temperatures, the electrons inside become excited which decreases the difference in voltage between the two sides of the batteries. Hence, efficiency of the batteries is reduced at high temperatures. As the batteries are manufactured to work between certain temperature extremes to deliver performance, such batteries cannot deliver intended performance and cycle life if there is no cooling system (natural or forced) to keep them in a working range. Cooling systems need to be able to keep the battery pack in the temperature range of about 20-40 degrees Celsius, as well as keep the temperature difference within the battery pack to a minimum (no more than 5 degrees Celsius).

Hence, there is a need for an improved battery pack for the electric vehicle and therefore address the aforementioned issues.

### BRIEF DESCRIPTION

In accordance with one embodiment of the disclosure, a battery pack for an electric vehicle is disclosed. The battery pack includes a cuboidal case of pre-defined dimension. The cuboidal case is configured to enclose one or more battery cells. The cuboidal case includes four side walls, a base wall and a top cover wall. The four side walls include two opposite long side walls and two opposite short side walls.

The two opposite long side walls and the base wall of the cuboidal case is attached with a plurality of structural fins longitudinally. The plurality of structural fins is configured to increase surface area of the cuboidal case and allow heat dissipation by convection process from the one or more battery cells. Furthermore, the battery pack also includes a phase change material packed within the cuboidal case. The phase change material is configured to maintain temperature range at higher discharge and hot temperature regions within the battery pack.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a perspective view of a battery pack associated with an electric vehicle in accordance with an embodiment of the present disclosure;

FIG. 2 is a side view of the battery pack in accordance with an embodiment of the present disclosure;

FIG. 3 is a front view representing the short side wall of the battery pack in accordance with an embodiment of the present disclosure;

FIG. 4 is a left perspective view of another exemplary battery pack associated with an electric vehicle in accordance with an embodiment of the present disclosure;

FIG. 5 is a right perspective view of another exemplary battery pack associated with an electric vehicle in accordance with an embodiment of the present disclosure;

FIG. 6 is a side view representing the long side wall of the battery pack in accordance with an embodiment of the present disclosure;

FIG. 7 is a top view of another exemplary battery pack in accordance with an embodiment of the present disclosure;

FIG. 8 is a top view of the battery pack coupled with an exemplary two-wheeler electric vehicle body frame in accordance with an embodiment of the present disclosure;

FIG. 9 is a side view of the battery pack coupled with an exemplary two-wheeler electric vehicle body frame in accordance with an embodiment of the present disclosure;

FIG. 10 is a top perspective view of the battery pack coupled with an exemplary two-wheeler electric vehicle body frame in accordance with an embodiment of the present disclosure;

FIG. 11 is a perspective view of the battery pack coupled with another exemplary two-wheeler electric vehicle body frame in accordance with an embodiment of the present disclosure;

FIG. 12 is a front view of an exemplary two-wheeler electric vehicle in accordance with an embodiment of the present disclosure; and

FIG. 13 is a side view of the exemplary two-wheeler electric vehicle in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated online platform, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or subsystems or elements or structures or components preceded by “comprises . . . a” does not, without more constraints, preclude the existence of other devices, subsystems, elements, structures, components, additional devices, additional subsystems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

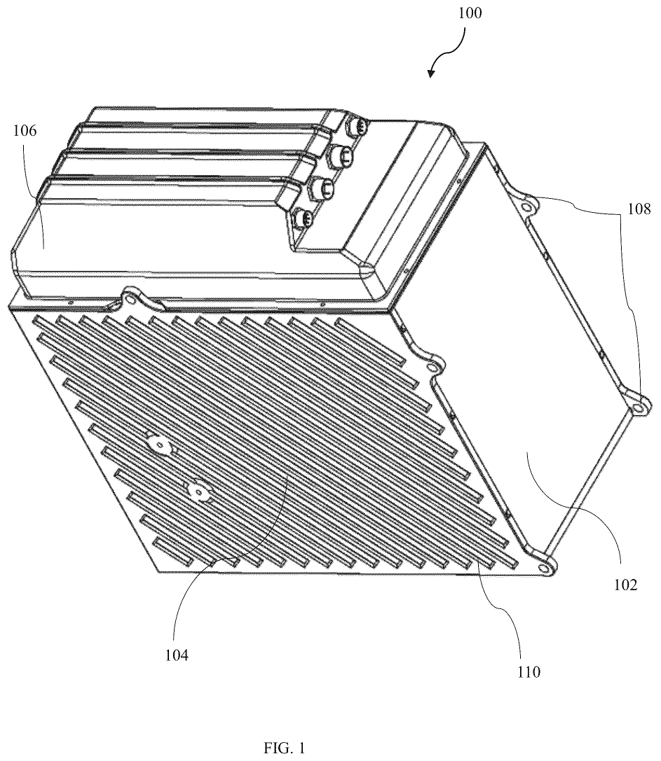

FIG. 1 is a perspective view of a battery pack 100 associated with an electric vehicle in accordance with an embodiment of the present disclosure. The electric vehicle is an automobile that is propelled by one or more electric motors, using energy stored in battery cells. In one embodiment, the electric vehicles may be of two-wheelers, three-wheelers, four-wheelers and the like. In such embodiment, the battery cells are packed together to form a battery module. Further, one or more battery modules are packed together to form a battery. One or more battery cells is enclosed in a cuboidal battery pack 100 as shown. In such embodiment, the one or more battery cells may also be any known batteries in the art.

The battery pack 100 includes a cuboidal case of pre-defined dimension. The cuboidal case is configured to enclose the one or more battery cells. The cuboidal case includes four side walls 102 and 104, a base wall and a top cover wall 106. In such embodiment, the cuboidal case height dimension is of 475.25 mm. In another such embodiment, the four side walls 102 and 104 comprise two opposite long side walls 104 and two opposite short side walls 102. In one specific embodiment, the cuboidal case may have the length dimension of about 443.5 mm, the width dimension of about 222 mm, and the height dimension of about 346 mm.

In yet another embodiment, the four side walls 102 and 104, the base wall and the top cover wall is fabricated with aluminium material. During operation, the one or more battery cells generate heat, and the aluminium material help to dissipate heat more effectively.

The one or more battery cells works upon voltage difference between positive and negative terminals. As the power demand of the electric vehicle increases during initial acceleration or during any other operations, current discharge of each of the one or more battery cells becomes high. High current discharge leads to increase in temperature of the battery pack 100. The fabrication material of the battery pack 100 help in conduction cooling.

In one specific embodiment, the two opposite long side walls 104 and the base wall of the cuboidal case is attached with a plurality of structural fins 110 longitudinally. In such embodiment, the plurality of structural fins 110 is distributed longitudinally in groups. The plurality of structural fins 110 is configured to increase surface area of the cuboidal case and allow heat dissipation by convection process from the one or more battery cells.

In such embodiment, the plurality of structural fins 110 increases 40 percent to 80 percent of the surface area of the cuboidal case. The plurality of structural fins 110 may include extruded or protruded out portion in the two opposite long side walls 104 and the base wall of the cuboidal case. The plurality of structural fins 110 may be added to all six walls if required to increase surface area as it helps in cooling.

The battery pack 100 also includes a phase change material packed within the cuboidal case. The phase change material is configured to maintain temperature range at higher discharge and hot temperature regions within the battery pack 100. During operation of the one or more battery cells, the phase change material helps in cooling of the battery pack 100. As used herein, the “phase change material (PCM)” is a substance which releases or absorbs sufficient energy at phase transition to provide useful heat or cooling. In one exemplary embodiment, the phase change material may be Glycol based coolant.

For cooling, heat transfers from the one or more battery cells to battery pack or cuboidal case via conduction with help of cell holders or any other coolant like phase changing material. The battery pack or cuboidal case transfers the heat via convection to atmosphere. In operation, the battery pack 100 receive the heat from the one or more battery cells, transmits the received heat to the cuboidal case, and dissipates the transmitted heat via a convection process through the plurality of structural fins 110.

As used herein, the term “conduction” refers to the process by which heat energy is transmitted through collisions between neighbouring atoms or molecules. As used herein, the term “convection” refers to a process by which heat is transferred by movement of a heated fluid such as air or water.

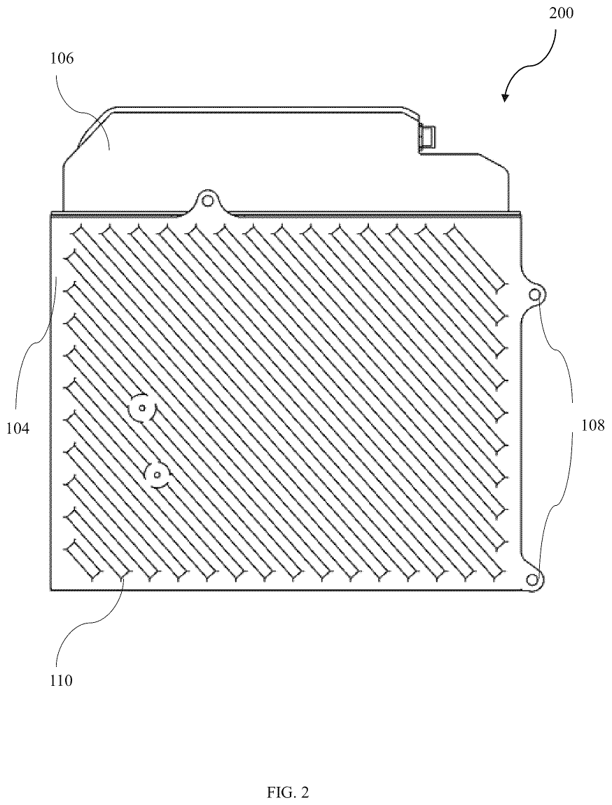

FIG. 2 is a side view 200 of the battery pack in accordance with an embodiment of the present disclosure. FIG. 2 clearly shows the arrangement of the plurality of structural fins 110 on one of the two long side walls 104. The battery pack 100 is also fabricated with one or more screw flanges 108 for mechanical coupling with the electric vehicle body frame. Each of the one or more screw flanges 108 are coupled to the vehicle body frame at specific points to hold the battery pack 100 at pre-determined position. The top cover wall 106 is coupled on the top portion with a top plastic cover. In one exemplary embodiment, the top plastic cover is of 100 mm to 111.22 mm range of width.

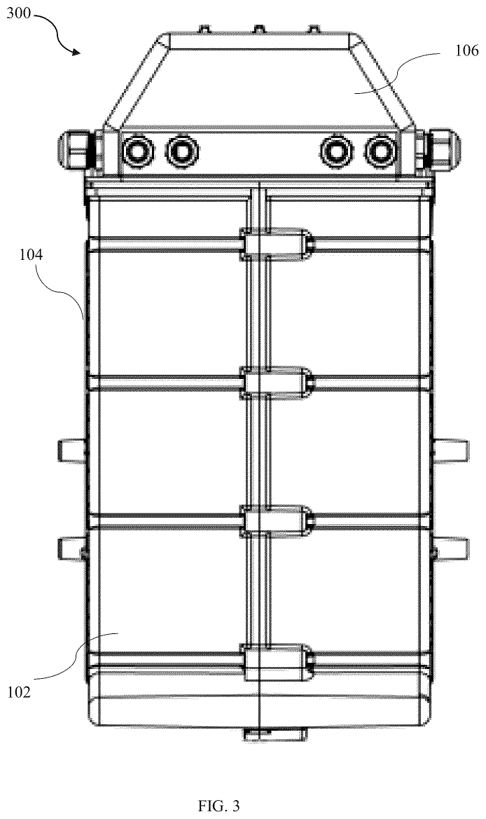

FIG. 3 is a front view 300 representing the short side wall of the battery pack in accordance with an embodiment of the present disclosure. The two opposite long side walls 104 and the two opposite short side walls 102 compactly holds the one or more battery cells and the phase changing material.

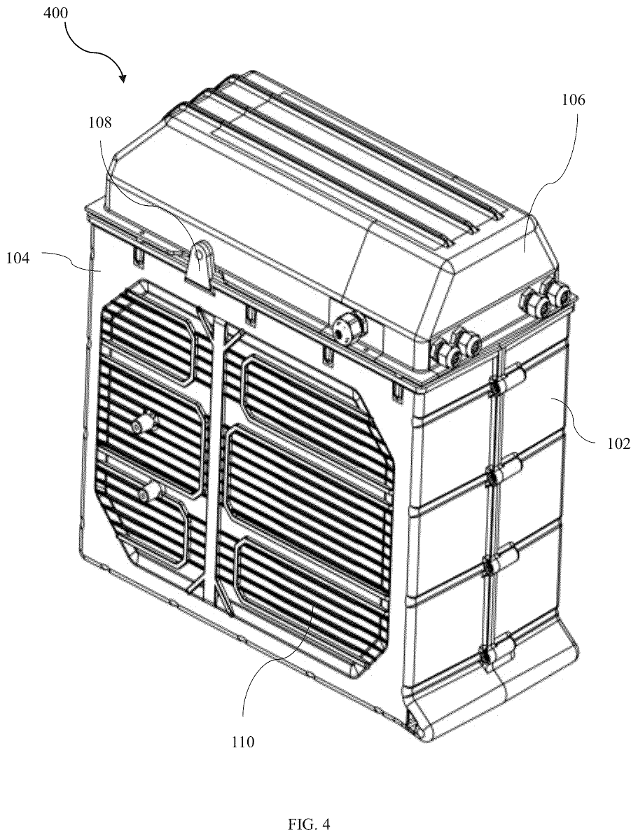

FIG. 4 is a left perspective view 400 of another exemplary battery pack associated with an electric vehicle in accordance with an embodiment of the present disclosure. The long side wall 104 of the battery pack 100 is attached with the plurality of structural fins 110 for cooling purpose. In such exemplary embodiment, the plurality of structural fins 110 are arranged longitudinally in six phases.

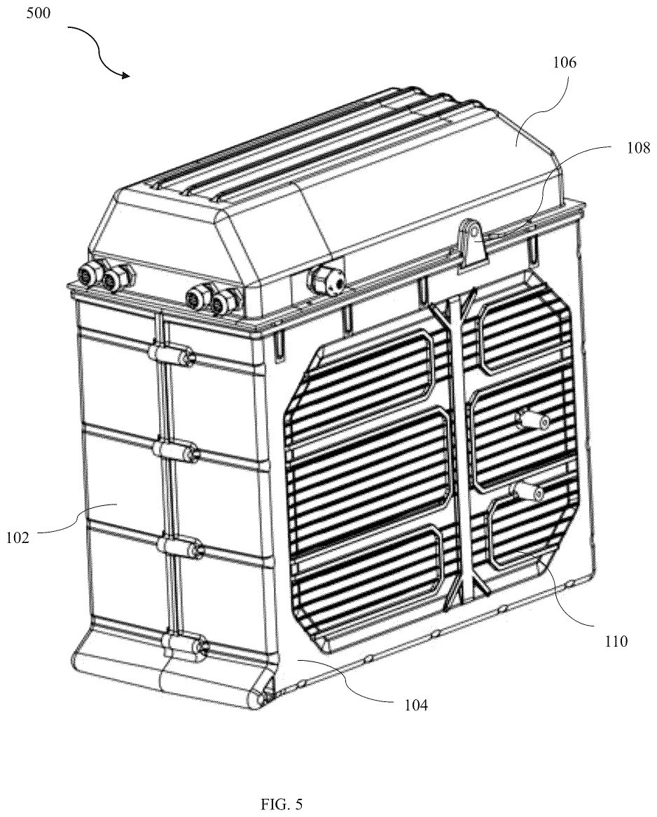

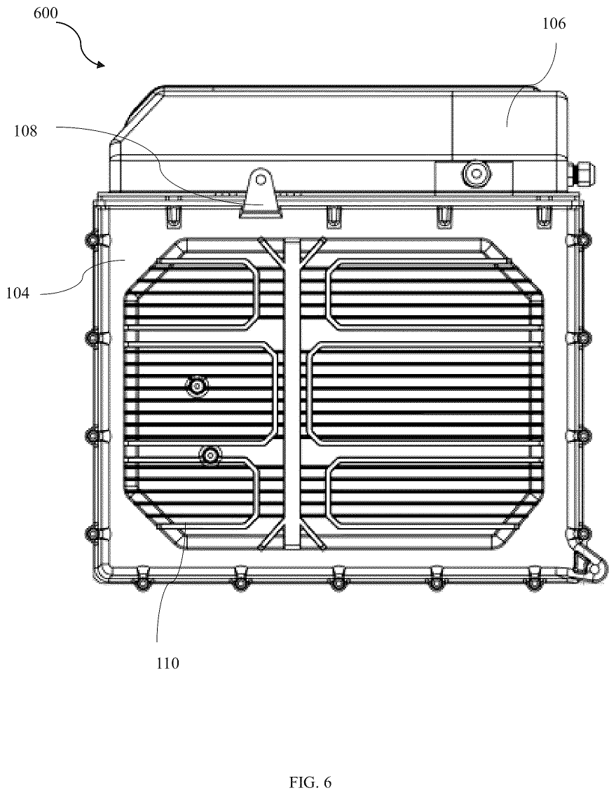

FIG. 5 is a right perspective view 500 of another exemplary battery pack associated with an electric vehicle in accordance with an embodiment of the present disclosure. The plurality of structural fins 110 are arranged longitudinally in six phases. The six phases of the plurality of structural fins 110 may be in designed in different shapes. In one exemplary embodiment, the different shapes may include hexagonal shape, octagonal shape and the like. FIG. 6 is a side view 600 representing the long side wall of the battery pack associated with an electric vehicle in accordance with an embodiment of the present disclosure.

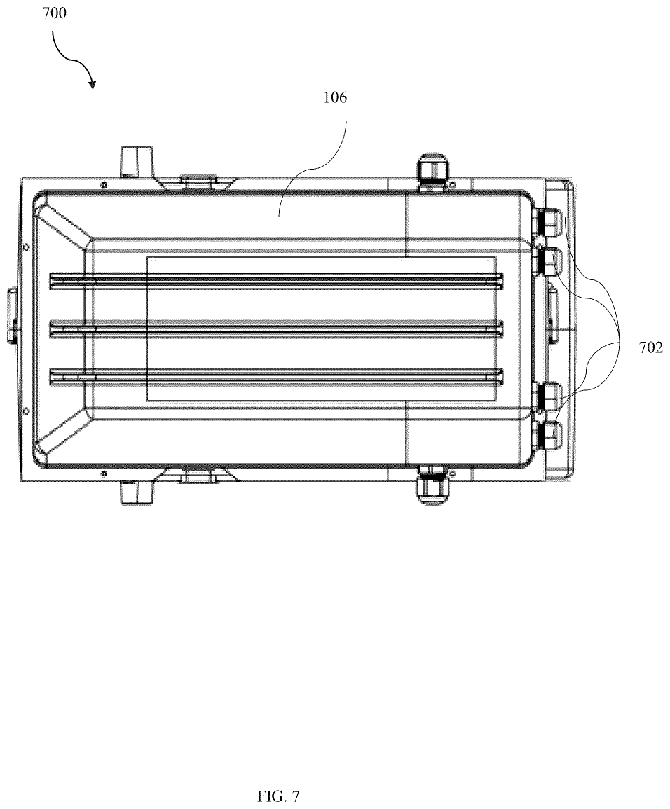

FIG. 7 is a top view 700 of another exemplary battery pack in accordance with an embodiment of the present disclosure. FIG. 7 illustrates that a top plastic cover is fabricated with one or more connection ports 702. In such embodiment, the one or more connection ports 702 helps in connecting the terminals of the battery modules with the motor component of the electric vehicle. The top cover wall 106 is configured to store a controller unit and provides four electrical coupling ports 702 for the motor component as well other auxiliaries.

In such exemplary embodiment, length of the battery pack 100 is 472.30 mm and width of the battery pack 100 is 222.00 mm. The one or more connection ports 702 helps in connecting the terminals of the battery modules to various electric vehicle components.

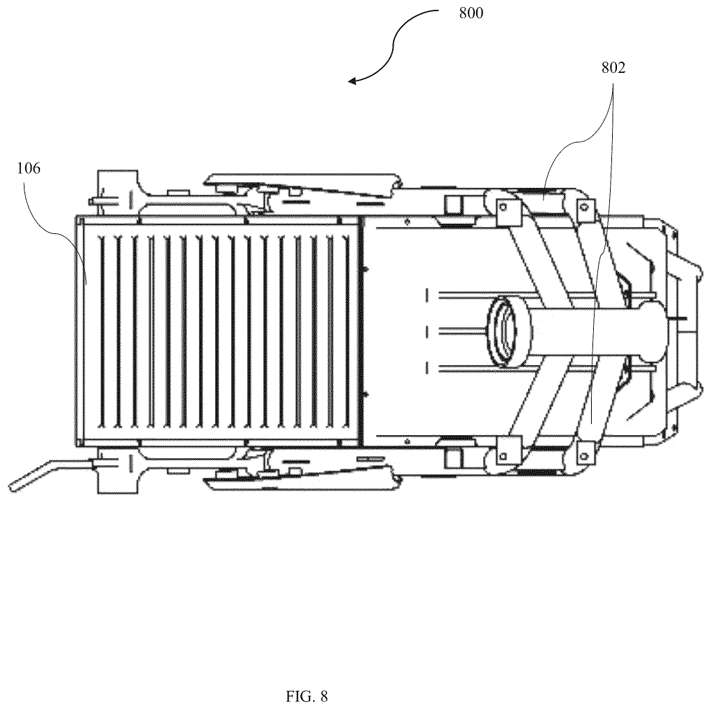

FIG. 8 is a top view 800 of the battery pack coupled with a two-wheeler electric vehicle body frame in accordance with an embodiment of the present disclosure. FIG. 8 illustrates compact holding of the battery pack 100 with the body frame 802 of the electric two-wheeler vehicle. In such embodiment, the top cover wall 106 is designed with two protruded mounts towards the top which is in turn screwed to body frame 802. Although FIG. 8 depicts a two-wheeler vehicle frame, a person skilled in the art may envision that the battery pack 100 may be mounted to any given electric vehicle frame. In such specific embodiment, the one or more screw flanges 108 are used for mechanical coupling of the battery pack 100 with the body frame 802.

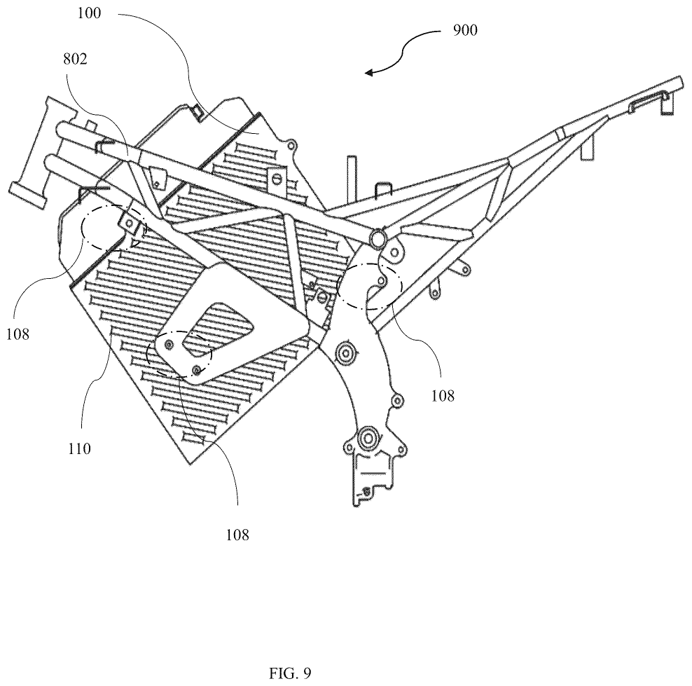

FIG. 9 is a side view 900 of the battery pack coupled with the two-wheeler electric vehicle body frame in accordance with an embodiment of the present disclosure. In such embodiment, one or more screw flanges 108 of the battery pack 100 is used for coupling the battery pack 100 with the two-wheeler electric vehicle body frame 802. On one side, the body frame 802 is coupled at four or more screw flanges 108. In total, the body frame 802 is coupled with eight or more screw flanges 108.

The arrangement of the battery pack 100 onto the vehicle body frame 802 is such that maximum number of side walls 104 having the plurality of structural fins 110 are exposed to air outside. This arrangement allows for faster dissipation of heat through convection. The long side walls of the battery pack 100 are designed with the plurality of structural fins 110. Although FIG. 19 depicts a two-wheeler vehicle frame, a person skilled in the art may envision that the battery pack 100 may be mounted to any given electric vehicle frame.

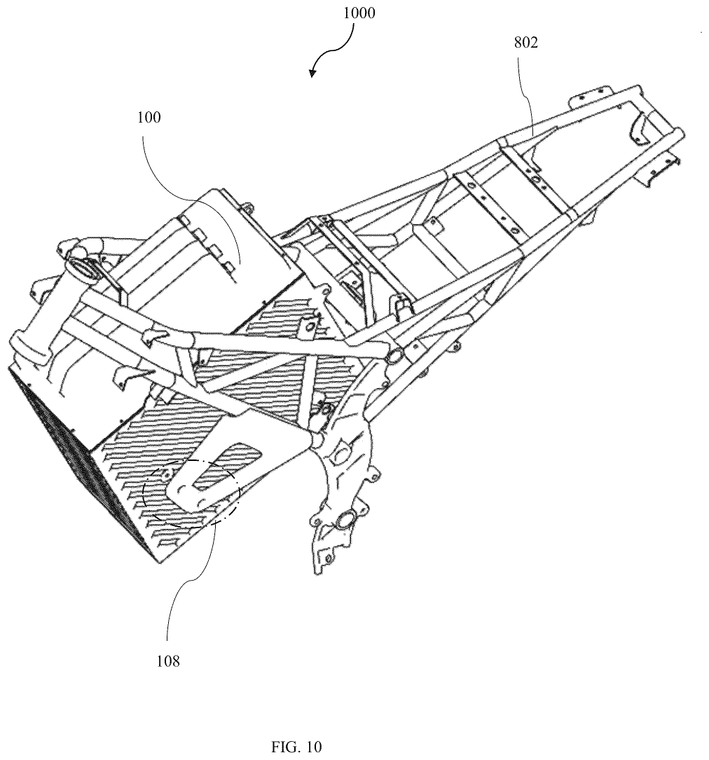

FIG. 10 is a perspective view 1000 of the battery pack coupled with the two-wheeler electric vehicle body frame in accordance with an embodiment of the present disclosure. FIG. 10 illustrates the compact fitting of the battery pack 100 with the two-wheeler electric vehicle body frame 802. The battery pack 100 is coupled through the one or more screw flanges 108. Although FIG. 10 depicts a two-wheeler vehicle frame, a person skilled in the art may envision that the battery pack 100 may be mounted to any given electric vehicle frame.

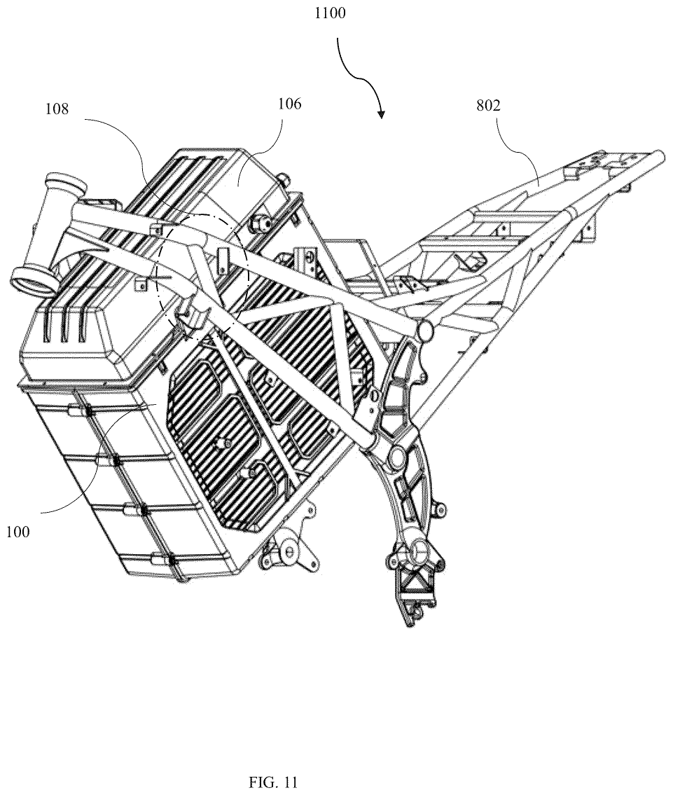

FIG. 11 is a perspective view 1100 of the battery pack coupled with another exemplary two-wheeler electric vehicle body frame in accordance with an embodiment of the present disclosure. In such exemplary embodiment, the plurality of structural fins 110 are arranged longitudinally in six phases. Maximum air exposure happens through such phase framework arrangement. In one specific embodiment, the battery pack 100 is mechanically coupled within two-wheeler electric vehicle body in an inclination arrangement. In such embodiment, the inclination allows maximum exposure to air for the two opposite long side walls 104 and the base wall.

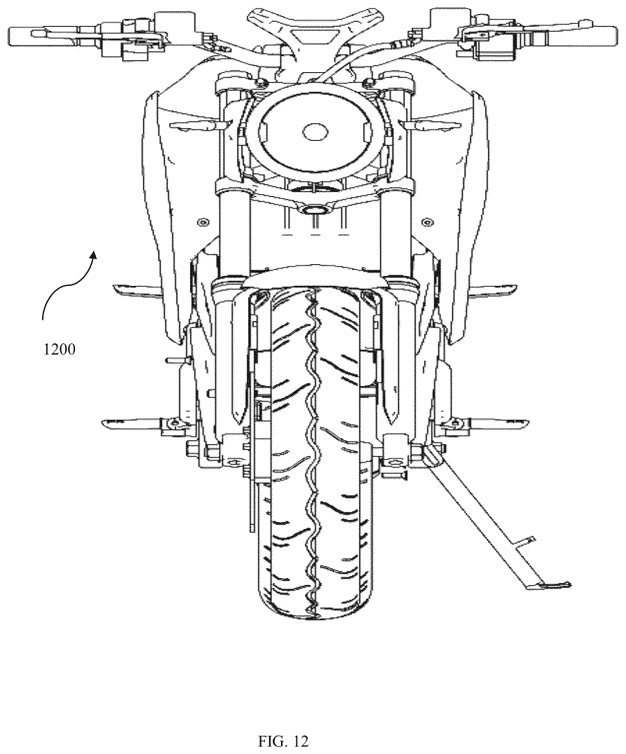

FIG. 12 is a front view 1200 of an exemplary two-wheeler electric vehicle in accordance with an embodiment of the present disclosure. The battery pack 100 is positioned on the front end of the two-wheeler electric vehicle body frame 802. Although FIG. 12 depicts a two-wheeler vehicle, a person skilled in the art may envision that the battery pack 100 may be mounted to any given electric vehicle.

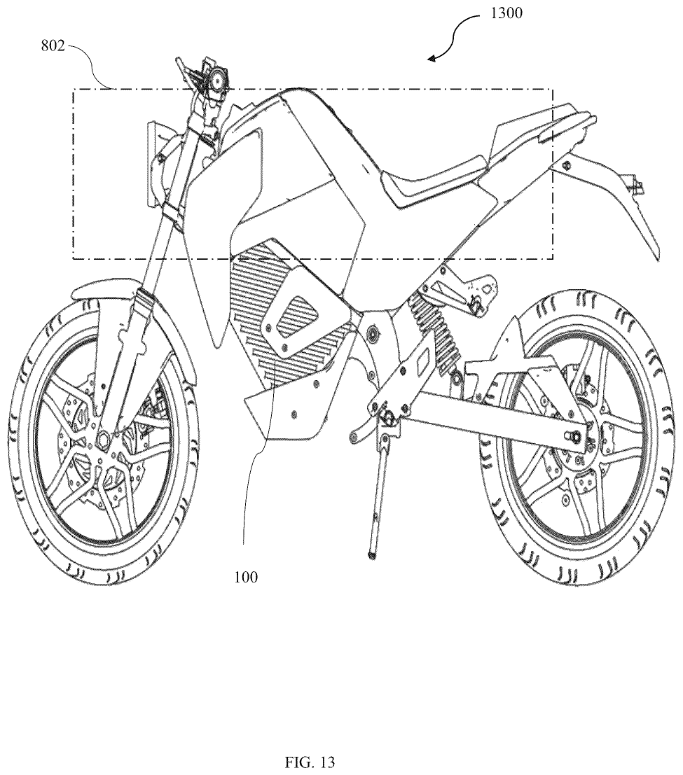

FIG. 13 is a side view 1300 of an exemplary two-wheeler electric vehicle in accordance with an embodiment of the present disclosure. The battery pack 100 is positioned in such a way that air can easily pass or interact with the plurality of structural fins 110 on two opposite long side walls 104 and the base wall. The interaction helps in easy convectional cooling of the generated heat of the one or more battery cells. The battery pack 100 is mounted with the two-wheeler electric vehicle body frame 802. The two-wheeler electric vehicle body frame 802 also compactly holds the seat, storage box, and the like. Although FIG. 13 depicts a two-wheeler vehicle, a person skilled in the art may envision that the battery pack 100 may be mounted to any given electric vehicle.

Various embodiments of the present disclosure provide a battery pack 100 for the electric vehicle. Also, a mechanism for achieving natural cooling of battery pack 100 for the electric vehicle is disclosed. The battery pack 100 is fabricated with aluminium material as it helps in fast conduction or convection cooling because of its thermal conductivity. Thermal conductivity of aluminium is five times more than mild steel. Furthermore, the plurality of structural fins 110 help in easy convection cooling, as the extruded fin 110 structure increases the surface area for cooling. The whole design helps in economical passive cooling of the battery.

The battery pack 100 designing may easily be used in all types of electric vehicles. Two-wheelers, four-wheeler, and the like may be fabricated with such enclosed case designing. Moreover, the effective cooling by such design will increase mileage of the electric vehicle as performance degradation is prevented by means. Furthermore, the battery pack 100 also contains the phase change material, which is configured to maintain temperature range at higher discharge and hot temperature regions within the battery pack 100. The battery pack 100 keeps battery temperature between 20-40 degree Celsius.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A battery pack for an electric vehicle, the battery pack comprising:
a cuboidal case of pre-defined dimension and configured to enclose one or more battery cells,
wherein the cuboidal case comprises four side walls, a base wall and a top cover wall, wherein the four side walls comprise two opposite long side walls and two opposite short side walls;
wherein the two opposite long side walls and the base wall of the cuboidal case is attached with a plurality of structural fins longitudinally,
wherein the plurality of structural fins is configured to increase surface area of the cuboidal case and allow heat dissipation by convection process from the one or more battery cells; and
a phase change material packed within the cuboidal case and configured to maintain temperature range at higher discharge and hot temperature regions within the battery pack.

2. The battery pack as claimed in claim 1, wherein the four side walls, the base wall and the top cover wall is fabricated with aluminium material.

3. The battery pack as claimed in claim 1, wherein the two opposite long side walls and the base wall are inclined to a vehicle body frame via one or more screw flanges, wherein the inclination allows maximum exposure to air for the two opposite long side walls and the base wall.

4. The battery pack as claimed in claim 3, wherein each of the one or more screw flanges are coupled to the vehicle body frame at one or more points to hold the battery pack at pre-determined position.

5. The battery pack as claimed in claim 1, wherein the plurality of structural fins increases 40 percent to 80 percent of the surface area of the cuboidal case.

6. The battery pack as claimed in claim 1, wherein the battery pack is configured to:
receive the heat from the one or more battery cells;
transmit the received heat to the cuboidal case and enable cooling via conduction process; and
dissipate the transmitted heat via a convection process through the plurality of structural fins.

7. The battery pack as claimed in claim 1, wherein the top cover wall comprises a top plastic cover, wherein the top plastic cover is fabricated with one or more connection ports, wherein the top cover wall is configured to store a controller unit.

8. The battery pack as claimed in claim 7, wherein the one or more connection ports is configured to enable connection of the terminals of battery modules with the motor component of the electric vehicle.

9. The battery pack as claimed in claim 1, wherein the battery pack is positioned on the front end of the two-wheeler electric vehicle body frame.
